(19) United States
(12) Patent Application Publication
(10) Pub. No.: US 2026/0350230 A1
(43) Pub. Date: Nov. 5, 2026

(54) System and Method for Dual Blockchain Verification of Creative Work Authorship Rights

(71) Applicant: SongProof Inc., Milton (CA)

(72) Inventors: Nadimur Rahman, Montreal (CA); Mario Biferali, Montreal (CA); Hina Rizvi, Milton (CA)

(21) Appl. No.: 19/320,387

(22) Filed: Sep. 5, 2025

Related U.S. Application Data
(60) Provisional application No. 63/798,170, filed on May 1, 2025.

(51) Int. Cl. G06F 21/64; G06F 21/60

(52) U.S. Cl. CPC G06F 21/64; G06F 21/602; G06F 2221/2151

(57) ABSTRACT

A dual-blockchain verification system provides tamper-proof authorship evidence for digital creative works by coordinating timestamping and recording across multiple blockchain networks. The system receives digital media files and metadata, generates SHA-256 cryptographic hashes, and creates structured JSON data objects containing hash values and ownership information. The system timestamps cryptographic hashes on Bitcoin's blockchain through OpenTimestamps service for legal durability while recording complete JSON data packages on Polygon's blockchain through smart contract execution for immediate verification. Transaction confirmations from both networks validate successful recording. The system generates self-contained digital ownership certificates containing original files, JSON proof objects, blockchain verification data, and independent validation tools enabling third-party verification without centralized authorities. This dual-blockchain architecture eliminates single points of failure, reduces verification time compared to traditional copyright registration processes, and provides creators with immediately accessible, independently verifiable ownership evidence for intellectual property protection and legal proceedings.

### CROSS-REFERENCE TO RELATED APPLICATIONS

The present application claims the priority benefit of U.S. Provisional Patent Application No. 63/798,170, filed May 1, 2025, which application is incorporated by reference in its entirety herein.

### FIELD OF THE INVENTION

The various exemplary embodiments herein generally relate to digital rights management and copyright protection. More particularly, the various exemplary embodiments herein relates to systems and methods of leveraging blockchain technology to provide timestamp-based authorship verification for musical works and other creative content.

### BACKGROUND

Musicians, composers, and creative artists face escalating challenges in proving original authorship of their works, particularly with the rise of AI-generated content and rapid online distribution. While digital tools have made content creation easier, they have simultaneously created new vulnerabilities for establishing authorship when disputes arise.

Artists and creators lack accessible, cost-effective tools to create contemporaneous, tamper-proof evidence of their authorship that can be independently verified by third parties without relying on any single platform or service provider. This gap in available technology leaves creators vulnerable to authorship disputes and limits their ability to protect their intellectual property rights effectively.

Current digital rights management systems primarily detect unauthorized usage rather than establish original authorship. Platforms like YouTube's Content ID can identify copyrighted material usage but cannot verify who originally created the work or establish temporal priority between competing claims. These systems lack the cryptographic proof mechanisms and immutable timestamping capabilities necessary for legally enforceable authorship verification.

Existing blockchain-based timestamping services, such as conventional OpenTimestamps implementations, typically focus on single-blockchain approaches that fail to optimize for both immediate accessibility and long-term legal durability. While some blockchain solutions attempt to address intellectual property protection, these systems generally rely on NFT marketplaces or single-chain smart contracts that create dependencies on specific platforms or networks, introducing single points of failure that can compromise long-term ownership verification capabilities.

Manual copyright dispute processes, such as Digital Millennium Copyright Act (DMCA) takedown procedures, are slow, expensive, and often ineffective for independent creators. These processes require extensive documentation and legal resources while placing the burden of proof on creators who lack adequate tools for establishing authorship evidence.

Traditional copyright registration systems provide legal protection but require formal filing procedures, fees, and delays, impractical for creators producing large volumes of work or seeking immediate authorship evidence. These systems also lack the immediate, independent verification capabilities needed in fast-moving digital environments.

Existing blockchain solutions focus primarily on NFT marketplaces and digital asset trading rather than authorship verification. Current implementations typically use single-chain approaches that fail to optimize for both immediate accessibility and long-term legal durability.

Prior blockchain implementations for digital rights management suffer from significant limitations including dependence on centralized platforms for verification, lack of coordinated multi-network approaches that provide redundancy, and failure to integrate established legal frameworks with immediate verification needs. Current single-blockchain solutions cannot simultaneously provide the legal recognition associated with Bitcoin's established blockchain network and the speed and cost-effectiveness required for practical day-to-day verification workflows.

There exists a need for a system combining the immediacy and cost-effectiveness of modern blockchain technology with legal durability required for copyright protection, while providing independent verification capabilities that do not depend on centralized platforms or databases.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In some exemplary embodiments, the present disclosure is directed to a computer implemented method, comprising: receiving a digital media file and associated metadata from a user; generating a cryptographic hash of the digital media file locally before external transmission; creating a structured data object containing the cryptographic hash and the associated metadata formatted as a JSON object according to a predetermined schema; implementing a database-backed queue management for asynchronous blockchain submission processing; submitting the cryptographic hash to a first blockchain network configured for timestamping services that generate OpenTimestamps (.ots) proof files; receiving the OpenTimestamps (.ots) proof data from the first blockchain network; incorporating the OpenTimestamps (.ots) proof data into the structured data object; and subsequently submitting the structured data object to a second different blockchain network configured for smart contract execution and data recording using secure API communication protocols with authentication headers; implementing error detection monitoring for non-2xx HTTP responses and abnormal response times; implementing exponential backoff retry mechanisms for failed blockchain submissions; receiving, from the first blockchain network, a first transaction identifier and first block reference corresponding to the timestamping operation along with OpenTimestamps (.ots) proof data; receiving, from the second blockchain network, a second transaction identifier and second block reference corresponding to the recording operation; confirming successful timestamping and recording of the cryptographic hash and structured data object based on the received transaction identifiers and block references; and generating a self-contained digital ownership certificate containing the digital media file, both transaction identifiers, both block references, the OpenTimestamps (.ots) proof data, and verification instructions enabling independent third-party validation without centralized system access.

In some exemplary embodiments, the present disclosure is directed to a system, comprising: a processor; and a memory for storing instructions, the instructions being executed by the processor to: receive a digital media file and associated metadata from a user; generate a cryptographic hash of the digital media file locally within a secure processing environment before external transmission; create a structured data object that contains the cryptographic hash and the associated metadata formatted as a JSON object according to a predetermined schema; implement a database-backed queue management for asynchronous blockchain submission processing; submit the cryptographic hash to a first blockchain network configured for timestamping services that generate OpenTimestamps (.ots) proof files; receive, from the first blockchain network, a first transaction identifier and first block reference corresponding to the timestamping operation along with OpenTimestamps (.ots) proof data; incorporate the OpenTimestamps (.ots) proof data into the structured data object; subsequently submit the structured data object to a second different blockchain network configured for smart contract execution and recording using secure API communication protocols with authentication headers; implement error detection monitoring for non-2xx HTTP responses and abnormal response times; implement exponential backoff retry mechanisms for failed blockchain submissions; receive, from the second blockchain network, a second transaction identifier and second block reference corresponding to the smart contract recording operation; confirm successful timestamping and recording across both blockchain networks based on the received transaction identifiers and block references; and generate a self-contained digital ownership certificate containing the digital media file, the first transaction identifier, the second transaction identifier, the first block reference, the second block reference, the OpenTimestamps (.ots) proof data, and verification instructions enabling independent third-party validation without centralized system access.

In some exemplary embodiments, the present disclosure is directed to a non-transitory computer-readable storage medium including instructions being executable by one or more processors to perform the method operations described herein.

In some exemplary embodiments, the disclosed system and method may be implemented by creative content platforms, allowing artists to establish ownership evidence for their digital media files, effectively providing tamper-proof authorship verification required for copyright protection and legal proceedings. The system generates ownership certificates that complement existing copyright registration systems and provide admissible evidence under Federal Rules of Evidence for authentication and business records exceptions.

In some exemplary embodiments, the disclosed system may be configured to generate ownership certificates for digital media file creators, for defining: one or more validation rules that verify the authenticity and completeness of submitted digital media files and associated metadata; dual-blockchain timestamping and recording that provides both immediate verification through fast networks and long-term legal durability through established networks; and independent verification capabilities that enable third-party validation without relying on centralized systems.

In some exemplary embodiments, the disclosed system is configured to create unique digital fingerprints of digital media files based on their complete binary content, ensuring that any modification to the original file results in a completely different hash value.

In some exemplary embodiments, the disclosed system may be configured to coordinate sequential submissions to multiple blockchain networks, including OpenTimestamps service for Bitcoin timestamping with initial submission aggregation completing within approximately 300 seconds and final Bitcoin blockchain confirmation within approximately 60-120 minutes, followed by custom smart contracts for Polygon network recording with transaction confirmation typically completing within approximately 300 seconds.

In some exemplary embodiments, the disclosed system may be configured to assemble comprehensive proof packages containing original files, blockchain verification data, and independent validation tools to create self-contained ownership evidence.

In some exemplary embodiments, the disclosed system may be configured to provide verification mechanisms that enable independent parties to confirm authorship claims using publicly available blockchain tools and verification services.

In some exemplary embodiments, the disclosed system may be implemented as part of digital audio workstation software or as a separate service that interfaces with existing creative workflow tools.

Additional objects, advantages, and novel features will be set forth in part in the detailed description section of this disclosure, which follows, and in part will become apparent to those skilled in the art upon examination of this specification and the accompanying drawings or may be learned by production or operation of the example embodiments. The objects and advantages of the concepts may be realized and attained by means of the methodologies, instrumentalities, and combinations particularly pointed out in the appended claims.

### BRIEF DESCRIPTION OF THE DRAWINGS

These and other objects, features and advantages of the present disclosure will be better understood from the detailed description of preferred embodiments and examples thereof that follows with reference to the accompanying drawings, in which:

FIG. 1 is a system diagram of a blockchain-based music ownership verification system.

FIG. 2 is a flowchart illustrating a five-phase verification process workflow in accordance with the verification system of FIG. 1, according to exemplary embodiments.

FIG. 3 is a flowchart illustrating steps of a certificate generation method in accordance with the verification system of FIG. 1, according to exemplary embodiments.

FIG. 4 is a screenshot of an exemplary computer system that is used to implement embodiments according to the present disclosure.

### DETAILED DESCRIPTION OF EXAMPLE EMBODIMENTS

While the presently disclosed systems and methods are susceptible to embodiment in many different forms, there are shown in the figures and will herein be described in detail several specific embodiments with the understanding that the present disclosure is to be considered as an exemplification of the principles of the present technology and is not intended to limit the technology to the embodiments illustrated.

In addition, the terminology used herein for the purpose of describing particular embodiments of the present technology is to be taken in context. For example, the term “comprises” or “comprising” when used in this disclosure indicates the presence of stated features in a system or steps in a process but does not preclude the presence of additional features or steps.

While the following detailed description primarily uses musical compositions as illustrative examples to demonstrate the system's operation, it should be understood that the present invention relates more broadly to digital media files containing creative content, including but not limited to musical compositions, audio recordings, video content, digital artwork, written works, and other forms of creative digital media. The use of musical composition examples is for clarity of explanation and should not be construed as limiting the scope of the invention to musical works alone

For purposes of this disclosure, the following terms shall have the meanings set forth below:

Associated metadata as defined herein, refers to information related to the digital file including but not limited to creator identification, creation timestamps, collaboration details, split sheet information defining ownership percentages, copyright registration data, file format specifications, and other relevant ownership and attribution data.

BASE-64 encoding as defined herein, refers to the encoding format used to convert OpenTimestamps files into text format for efficient integration within the system's data processing workflow and JSON objects.

Bitcoin blockchain network as defined herein, refers to the established blockchain network operating continuously since 2009 that provides proven reliability and long-term archival capabilities for timestamping operations through the OpenTimestamps service.

Block reference as defined herein, refers to the specific blockchain block number or hash where a transaction is permanently recorded, providing the precise location within the blockchain's immutable ledger for verification purposes.

Blockchain events as defined herein, refers to permanent log entries stored in a blockchain's immutable transaction log that are emitted by smart contracts and contain ownership data as payload, ensuring cryptographically secured permanent storage and independent verification capabilities.

Blockchain explorer as defined herein, refers to publicly accessible search engines for blockchain data that allow users to enter transaction IDs and view complete records of what was stored on blockchain networks, enabling independent verification of ownership certificates.

Blockchain network as defined herein, refers to a distributed ledger system that maintains a continuously growing list of records secured using cryptographic principles, where data is stored across multiple nodes and validated through consensus mechanisms.

Blockchain verification data as defined herein, refers to cryptographic evidence generated through blockchain network operations, including transaction identifiers, block references, timestamps, cryptographic proof chains, OpenTimestamps (.ots) files from Bitcoin timestamping operations, smart contract transaction records from secondary blockchain networks, and other cryptographic evidence that provide cryptographically secured proof of data existence, timing, and integrity across multiple blockchain networks used in the dual-blockchain verification system.

Certificate generation as defined herein, refers to the process of assembling comprehensive digital ownership certificate packages by collecting components from all processing stages to create self-contained proof archives.

Cryptographic hash as defined herein, refers to a unique digital fingerprint generated by applying a cryptographic hashing algorithm such as SHA-256 to the complete binary content of a digital file, wherein any modification to the original file results in a completely different hash value, thereby providing mathematical proof of file integrity.

Digital media file as defined herein, refers to any digital file containing creative content stored in electronic format, including but not limited to digital image files, digital audio files, digital video files, digital text files, digital multimedia files, and other digital creative content files. Examples include musical compositions, audio recordings, video content, digital artwork (including JPEG, PNG, GIF, and other image formats), written works, photographs, digital graphics, multimedia presentations, and other forms of creative digital content. While the following detailed description primarily uses musical compositions as illustrative examples to demonstrate the system's operation, the present invention applies broadly to all forms of digital creative content, and the use of musical composition examples is for clarity of explanation and should not be construed as limiting the scope of the invention to musical works alone.

Digital ownership certificate as defined herein, refers to a self-contained proof package (such as a proof.zip archive) containing the digital file, associated blockchain verification data, transaction identifiers, block references, cryptographic proof chains, and independent validation tools that enable third-party verification of authorship claims by independent parties without requiring access to centralized systems, databases, or the original certification system.

Dual-blockchain verification as defined herein, refers to the sequential submission and recording of ownership data across two distinct blockchain networks, wherein first one network provides timestamping services for long-term legal durability and subsequently the other network provides smart contract-based recording for immediate verification capabilities.

Immutable as defined herein, refers to the characteristic of blockchain-stored data that cannot be altered, deleted, or modified after being confirmed and recorded in the blockchain network, ensuring permanent preservation of the recorded information.

Independent verification as defined herein, refers to the ability for third parties to validate ownership certificates using publicly available blockchain tools, blockchain explorers, and verification services without requiring access to the original certification system, centralized databases, or proprietary verification platforms.

JSON proof object as defined herein, refers to the comprehensive data package structured in JSON format that combines generated hash values with collected metadata, following a predetermined schema for blockchain submission requirements.

OpenTimestamps (.ots) files as defined herein, refers to portable cryptographic proof documents that contain the complete mathematical evidence needed to trace a document's cryptographic hash back to its permanent record in the Bitcoin blockchain, providing long-term validity and enabling independent verification without requiring access to any centralized service.

Polygon blockchain network as defined herein, refers to the Layer 2 scaling solution blockchain network that operates as a sidechain to Ethereum, providing faster transaction processing and lower costs while maintaining immutable blockchain security benefits for immediate verification and smart contract execution.

Predetermined schema as defined herein, refers to a standardized data structure format that defines required fields, data types, validation rules, and organization for the JSON proof object to ensure consistency, blockchain compatibility, and cross-platform interoperability.

SHA-256 algorithm as defined herein, refers to the specific cryptographic hashing algorithm that produces a unique 256-bit hash value serving as a mathematical representation of file contents.

Smart contract as defined herein, refers to a computer program that runs automatically on a blockchain network and executes predefined functions when specific conditions are met. In the system of the present disclosure, smart contracts include the storeJSON function used to process and permanently store ownership data on the Polygon blockchain network.

Split sheet information as defined herein, refers to data defining the precise ownership percentages and distribution among multiple creators or collaborators, including creator identification, contact information, and respective percentage stakes that must total 100% in aggregate.

StoreJSON function as defined herein, refers to a smart contract function that accepts and stores structured data objects as input parameters, validates data format, and emits blockchain events containing ownership information as permanent log entries within the broader smart contract system.

Structured data object as defined herein, refers to a JSON-formatted data package containing the cryptographic hash of the digital file, associated metadata, ownership information, timestamps, and other relevant data organized according to a predetermined schema for blockchain compatibility and verification purposes.

Timestamping as defined herein, refers to the process of creating cryptographic proof that a specific document or data existed at a particular point in time by anchoring its cryptographic hash to a blockchain transaction, thereby establishing temporal priority for authorship claims.

Transaction identifier as defined herein, refers to a unique alphanumeric string assigned by a blockchain network to identify a specific transaction, enabling independent parties to locate and verify the transaction details using blockchain explorers or other publicly available tools.

Validation mechanisms as defined herein, refers to the comprehensive checks performed on uploaded content including file format compatibility verification, size limitation enforcement, metadata completeness confirmation, and split sheet percentage validation.

### Overview

The present disclosure provides a dual-blockchain verification system that coordinates submissions across multiple blockchain networks to eliminate single points of failure and create independently verifiable ownership certificates that do not rely on centralized authorities. Unlike conventional single-blockchain approaches or traditional copyright registration systems, the disclosed system provides both immediate verification capabilities and long-term legal durability for establishing tamper-proof authorship evidence of digital creative works.

The system operates through a technically sophisticated process that generates cryptographic hashes of digital media files using SHA-256 algorithms, submits these hashes to Bitcoin's blockchain network via OpenTimestamps service for long-term legal recognition, and subsequently records complete ownership data packages on the Polygon blockchain network through smart contract execution for immediate verification. This dual-blockchain architecture leverages the unique strengths of each network: Bitcoin's established legal credibility and immutability for archival purposes, combined with Polygon's speed and cost-effectiveness for subsequent verification needs.

The disclosed system provides significant operational advantages over traditional copyright protection methods by eliminating complex registration procedures, reducing verification time compared to traditional copyright registration processes, and decreasing costs from hundreds of dollars to minimal transaction fees. Initial OpenTimestamps submission aggregation completes within approximately 300 seconds with final Bitcoin blockchain confirmation completing within 60-120 minutes, after which Polygon verification completes within approximately 300 seconds depending upon network conditions. Complete digital ownership certificates are typically generated and available for download within approximately 75-150 minutes depending on Bitcoin confirmation timing. The system enables creators to generate cryptographically secured ownership certificates that align with their creative workflows while maintaining legal enforceability. This technological approach enables proactive intellectual property protection that provides both immediate practical utility for day-to-day verification needs and robust legal protection for formal proceedings.

A “Digital Ownership Certificate” as used herein refers to a self-contained proof package that allows creators to establish, maintain, and verify their authorship claims through cryptographic hash generation, dual-blockchain timestamping and recording, and independent third-party validation capabilities. These certificates provide tamper-proof evidence of creation and ownership without requiring access to the original system or any centralized database.

To understand the technical advantages of utilizing multiple blockchain networks for ownership verification, it is helpful to examine the characteristics of Bitcoin and Polygon networks. Bitcoin represents the world's first and most established blockchain network, operating continuously since 2009 with widespread legal recognition that makes Bitcoin blockchain records particularly valuable for copyright disputes and admissible under Federal Rules of Evidence including Rules 803(6) for business records and 901 for authentication. OpenTimestamps leverages this legal credibility by permanently embedding document fingerprints into Bitcoin's blockchain network through timestamping, creating irrefutable proof of document existence without requiring cryptocurrency payments or wallet management.

In contrast, Polygon operates as a secondary blockchain network that provides faster transaction processing and significantly lower costs while maintaining blockchain security benefits. Initial OpenTimestamps submission aggregation completes within approximately 300 seconds with final Bitcoin blockchain confirmation taking approximately 60-120 minutes, after which Polygon smart contract transactions confirm within approximately 300 seconds at minimal cost. This sequential approach ensures Bitcoin's archival foundation is established before Polygon provides subsequent verification capabilities that complement the completed Bitcoin timestamping.

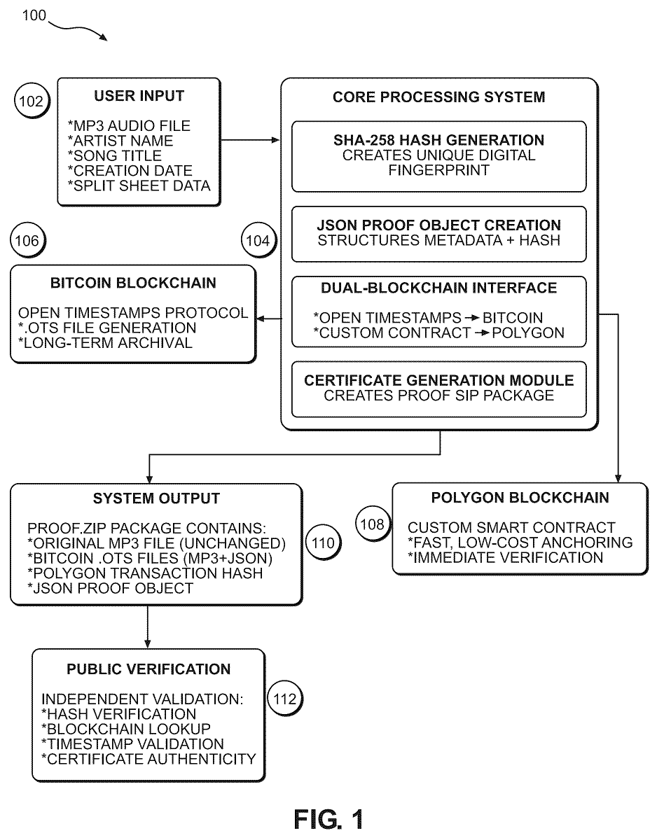

Turning now to the drawings, FIG. 1 illustrates an embodiment of an exemplary system architecture for implementing aspects of a blockchain-based music ownership verification system 100 of the present disclosure. The system architecture includes a User Input module 102 that interfaces with a Core Processing System 104, which connects to both a Bitcoin Blockchain integration module 106 and a Polygon Blockchain integration module 108. The Core Processing System 104 also interfaces with a System Output module 110 and a Public Verification module 112, all working together to process digital media files, generate cryptographic ownership evidence, and create independently verifiable digital certificates.

The sequential dual-blockchain architecture provides enhanced verification robustness by utilizing independent blockchain networks that each contribute distinct capabilities to the ownership evidence, distinguishing it from traditional distributed consensus systems that depend on agreement among all participating nodes. The system leverages the independent verification strengths of each blockchain network to create sequential proof pathways that strengthen the overall evidence package, with Bitcoin processing completing first before Polygon processing begins, while both networks contributing to the comprehensive ownership verification.

In this embodiment, the blockchain-based verification system 100 operates through five distinct phases: Initial Input Collection, Cryptographic Processing, Dual-Blockchain Anchoring, Certificate Generation, and Verification Enablement. This phased approach ensures systematic processing while maintaining data integrity and providing multiple validation checkpoints throughout the workflow.

In this exemplary embodiment, the system 100 initiates operation when the User Input module 102 receives a digital media file and associated metadata from a creator seeking to establish ownership evidence. The User Input module 102 serves as the primary ingress point for creators uploading their creative works and entering ownership information necessary for certificate generation. For example, in a typical musical work scenario, a songwriter might upload a digital media file, such as an MP3 file, of their newly composed song “Dream High” along with metadata identifying themselves as “John Doe” from California, indicating a creation date of Jun. 11, 2025, and specifying collaboration details through split sheet data showing a 60% ownership stake for the primary songwriter and 40% ownership for a co-writer “Jane Smith.” In some embodiments, the incoming data may contain the original media file, artist identification, song details, creation timestamps, and collaboration information including split sheet data that defines ownership percentages among multiple creators.

The User Input module 102 performs comprehensive validation of uploaded content to ensure data integrity before processing. The validation mechanisms verify file format compatibility with supported audio formats (preferably MP3), enforce size limitations (e.g., 50 MB maximum though it is contemplated that larger limits may be supported in future implementations), confirm metadata completeness, and validate that split sheet percentages total exactly 100% when multiple collaborators are involved, implement file integrity checks to detect corruption, and verify that metadata fields conform to required data types and formats. Upon successful validation, the module forwards the verified content to downstream processing components.

Upon receiving validated input from the User Input module 102, the Core Processing System 104 orchestrates the cryptographic processing workflow, acting as the primary coordination layer that manages interactions between various processing components required to create tamper-proof ownership evidence. The system maintains the business logic for generating cryptographic hashes, structuring metadata, and coordinating blockchain submissions. The Core Processing System 104 implements a database-backed queue management system that handles blockchain submissions asynchronously while maintaining transaction integrity and providing automatic retry capabilities for failed operations. Specifically, the Core Processing System 104 generates a SHA-256 cryptographic hash of the received digital media file locally within the secure processing environment before any external transmission occurs. The system reads the complete binary content without any compression, modification, or alteration. This creates a unique 256-bit digital fingerprint that serves as a mathematical representation of the file's exact contents. Any subsequent modification to the original file, even a single bit change, would result in a completely different hash value, thereby providing cryptographic proof of file integrity and authenticity.

After generating the SHA-256 hash of the digital media file, the Core Processing System 104 creates a structured JSON proof object that combines the generated hash with the collected metadata. The system transmits this structured data using POST requests with JSON payloads, appropriate content-type headers (application/json), and authentication headers to ensure secure API-to-API communication integrity. This JSON object serves as a comprehensive data package containing all relevant information about the digital media file and its ownership, including song metadata, the SHA-256 hash, UTC timestamps, split sheet information, and file characteristics. The JSON structure follows a predetermined schema that ensures consistency and compatibility with blockchain submission requirements, creating a standardized format for ownership documentation.

In one embodiment, the JSON proof object is structured as follows:

```
{
  “data”: {
    “song_id”: “abc123”,
    “song_name”: “Dream High”,
    “user”: {
      “name”: “John Doe”,
      “email”: “john@example.com”,
      “country”: “USA”,
      “state”: “California”,
      “registered_at”: “2025-06-11T10:20:30Z”
    },
    “splitsheet”: [
      {
        “name”: “John Doe”,
        “email”: “john@example.com”,
        “percentage”: 60
      },
      {
        “name”: “Jane Smith”,
        “email”: “jane@example.com”,
        “percentage”: 40
      }
    ]
  },
  “hash”: “0b11ff20565ed69cd08b577eb5762d8631786a32eb83936061b48763fdd0bb5b”,
  “songOTS”: “RG8geW91IGhhdmUgdG8gZGVhbCB3aXRoIEJhc2U2N...”,
  “dataOTS”: “SGVyZSBpcyBhbm90aGVyIEJhc2U2NCBlbmNvZGVk...”
}
```

The ‘songOTS’ and ‘dataOTS’ fields shown above represent BASE-64 encoded OpenTimestamps files that are generated during the Bitcoin timestamping process, as described in detail below. Further, the hash values shown are abbreviated for readability, actual SHA-256 hashes are 64-character hexadecimal strings. These BASE-64 encoded .ots files can be decoded at any time to regenerate the original OpenTimestamps verification files, providing ongoing access to Bitcoin blockchain verification data even if users lose their original proof.zip certificate packages.

The predetermined JSON schema ensures consistent data structure across all blockchain submissions and includes mandatory fields for core ownership data, optional fields for extended metadata, and validation rules that verify data completeness before blockchain submission. The schema implements version control mechanisms to accommodate future enhancements while maintaining backward compatibility with existing ownership certificates, ensuring long-term accessibility and verification capabilities.

### System Architecture—Specialized Modules

The blockchain-based verification system 100 architecture further includes specialized modules that coordinate the dual-blockchain verification process. Each module performs distinct functions within the overall workflow, from interfacing with external blockchain networks to assembling final ownership certificates and enabling independent verification. The following modules work together to implement the comprehensive verification system:

The Bitcoin Blockchain integration module 106 handles communication with the OpenTimestamps service, managing the submission of cryptographic hashes for long-term timestamping to the Bitcoin blockchain network and generating portable .ots verification files that provide indefinite proof validity. The module implements communication protocols that handle asynchronous confirmation processes and include timeout management and exponential backoff retry mechanisms for network interruptions or service unavailability.

The Polygon Blockchain integration module 108 manages smart contract interactions on the Polygon network, submitting complete data packages to custom smart contracts for immediate verification capabilities and receiving transaction confirmations for real-time ownership record access. The module implements transaction monitoring protocols that track submission status through API polling at predetermined intervals and provide JSON response data containing transaction hashes, block numbers, and timestamps for successful recordings.

The System Output module 110 assembles comprehensive digital ownership certificate packages by collecting components from all processing stages, creating self-contained proof.zip archives that enable independent third-party verification without requiring access to the original system.

The Public Verification module 112 provides the infrastructure and documentation necessary for completely autonomous verification using publicly available blockchain tools and services, ensuring that ownership evidence remains valid and verifiable regardless of the continued operation of the certification system.

These four specialized modules work in coordination to transform the abstract concept of ownership verification into a concrete, independently verifiable technical process that eliminates single points of failure while providing both immediate practical utility and long-term legal protection.

### Process Phase Flowchart

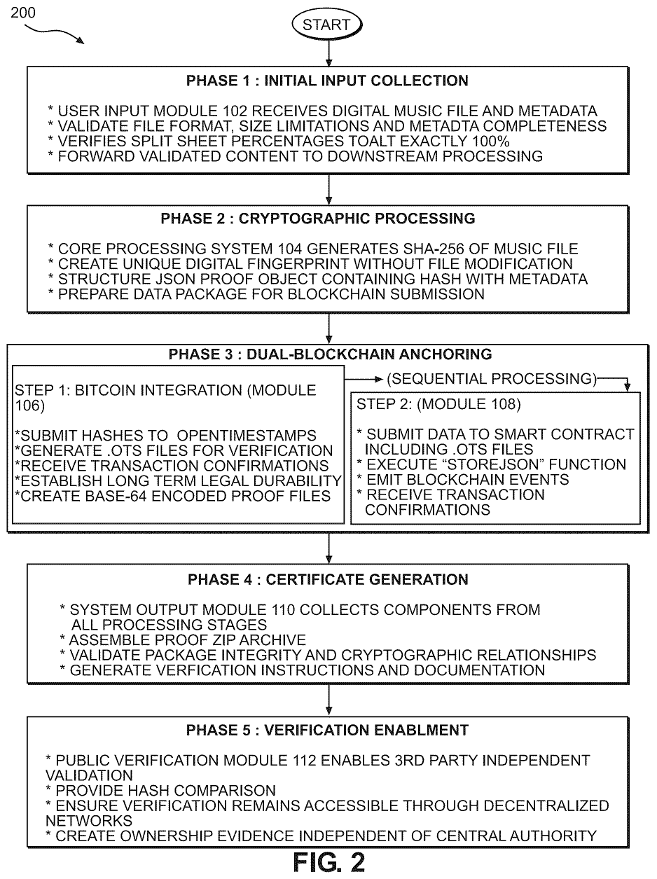

Referring now to FIG. 2, there is shown an embodiment of a process phase flowchart illustrating the high-level operational workflow of the blockchain-based verification system 100 previously described in connection with FIG. 1. The flowchart demonstrates how the system components work together in a coordinated sequence of five distinct phases, each building upon the outputs of the previous phase to create comprehensive ownership verification evidence.

As shown in FIG. 2, the system operates through five sequential phases that transform user-provided creative content into independently verifiable ownership certificates. Phase 1 handles initial input collection and validation, Phase 2 performs cryptographic processing and data structuring, Phase 3 executes dual-blockchain anchoring sequentially through first Bitcoin processing and then Polygon processing, Phase 4 assembles the comprehensive certificate package, and Phase 5 enables independent verification capabilities. This phased approach ensures systematic processing while maintaining data integrity and providing multiple validation checkpoints throughout the workflow that include input validation, cryptographic verification, blockchain confirmation monitoring, and certificate integrity validation.

### Process Phase 1—Initial Input Collection Phase

The initial input collection phase begins the ownership verification process by receiving digital media files and associated metadata from creators as external inputs to the system 100. The User Input module 102, as shown in FIG. 1, serves as the primary ingress point for this external data. This phase establishes the foundation for all subsequent processing by performing comprehensive validation of the submitted content, including validating file format compatibility, enforcing size limitations, ensuring metadata completeness, and verifying that split sheet percentages total exactly 100% when multiple collaborators are involved. These validation mechanisms prevent data integrity issues and mathematical inconsistencies that could compromise ownership documentation. Upon successful validation, this phase outputs the verified digital media file and validated metadata package to Phase 2, ensuring that only properly formatted and complete submissions proceed to the cryptographic processing stage.

### Process Phase 2—Cryptographic Processing Phase

The cryptographic processing phase receives the verified digital media file and validated metadata package from Phase 1 and transforms these validated inputs into tamper-proof digital evidence. During this phase, the system generates SHA-256 cryptographic hashes of the digital media files as described in the Core Processing System operation above, creating unique digital fingerprints that serve as mathematical proof of file integrity. This phase also structures the generated hash values and collected metadata into JSON proof objects that follow predetermined schemas for blockchain compatibility, outputting the original digital media file, SHA-256 cryptographic hash values, and structured JSON proof object to Process Phase 3.

### Process Phase 3—Dual-Blockchain Timestamping and Recording Phase

Following the completion of Phase 2 cryptographic processing, the system 100 proceeds to Phase 3, the dual-blockchain timestamping and recording phase, which establishes permanent, tamper-proof records of the ownership evidence on two distinct blockchain networks. This phase receives the original digital media file, SHA-256 hash values, and structured JSON proof object from Phase 2 as its inputs and operates sequentially through first the Bitcoin Blockchain integration module 106 and then the Polygon Blockchain integration module 108. This phase first processes the hash values for blockchain timestamping and upon completion stores the JSON proof object with the generated .ots files for blockchain recording, while passing all original inputs through unchanged to Phase 4 for certificate assembly. The timestamping and recording process creates the foundational blockchain evidence that enables independent third-party verification of ownership claims without relying on any centralized authority. The Bitcoin integration component submits the SHA-256 hash values, for both the digital media file hash and the JSON proof object hash, to the OpenTimestamps service, generates .ots verification files, and establishes long-term legal durability through Bitcoin's established legal recognition. After Bitcoin processing completes, the Polygon integration component submits the complete JSON proof object with all metadata and the generated .ots files to custom smart contracts, executes “storeJSON” functions, emits blockchain events, and receives transaction confirmations for immediate verification capabilities. This phase outputs the original digital media file, the .ots verification files from Bitcoin processing, the JSON proof object, and the Polygon transaction references to Phase 4, providing the complete set of blockchain timestamped and recorded evidence needed for certificate assembly. The following table illustrates how each input is processed across both blockchain networks during Phase 3:

TABLE 1
Phase 3 Dual-Blockchain Network Processing

| | | Bitcoin | | | |
|---|---|---|---|---|---|
| | | Blockchain | Polygon | Outputs to Phase 4 | |
| | Received | Network | Blockchain | | Newly |
| Input | from | Processing (via | Network | Unchanged | Generated |
| Type | Phase 2 | OpenTimestamps) | Processing | Items | Items |
| Original | Complete | No direct | No direct | Complete | None |
| Digital | digital media | processing | processing | digital media | |
| Media | file | | | file | |
| File | | | | | |
| Digital | SHA-256 | Timestamped to | Not | SHA-256 | Bitcoin .ots |
| Media File | cryptographic | Bitcoin blockchain | processed | cryptographic | file for |
| Hash | hash of | via | | hash of | digital |
| | digital media | OpenTimestamps | | digital media | media file |
| | file | service | | file | |
| JSON | Complete | Hash of JSON | Complete | JSON proof | Bitcoin .ots |
| Proof | metadata | timestamped to | JSON stored | object | file for |
| Object | package | Bitcoin blockchain | via smart | | JSON |
| | | via | contract | | object + |
| | | OpenTimestamps | | | Polygon |
| | | | | | transaction |
| | | | | | reference |
| JSON | SHA-256 | Timestamped to | Not | SHA-256 | Bitcoin .ots |
| object hash | cryptographic | Bitcoin blockchain | Processed | cryptographic | file for |
| | hash of | via | | hash of | JSON |
| | JSON | OpenTimestamps | | JSON | object |
| | | service | | | |

Notably, the JSON proof object uniquely benefits from sequential dual-network processing: the Bitcoin blockchain network first timestamps a hash of the JSON object for long-term legal durability, after which the Polygon blockchain network stores the complete JSON content for immediate accessibility and verification.

Phase 3 coordinates these dual-blockchain submissions through a sequential processing architecture. The system initiates Bitcoin blockchain operations first while maintaining transaction monitoring for the network. The system implements sequential processing protocols that require initial OpenTimestamps submission aggregation to complete within approximately 300 seconds with final Bitcoin blockchain confirmation completing within 60-120 minutes before Polygon smart contract execution begins and confirms within approximately 300 seconds. The system utilizes a database-backed queuing mechanism that manages blockchain submission timing, handles network congestion through automatic re-broadcast protocols when transactions remain pending beyond 5-minute thresholds, and implements retry logic for failed transactions. The sequential blockchain submission approach ensures that Bitcoin processing must complete successfully before Polygon operations begin, with the Bitcoin-generated .ots files becoming part of the data package submitted to Polygon. This sequential dependency is technically necessary because the Polygon smart contract requires the BASE-64 encoded OpenTimestamps data as part of the complete ownership record, creating an inherent processing order that cannot be altered without compromising the integrity of the dual-blockchain verification system. The following sections detail how each blockchain network processes the submitted data.

With continued reference to FIG. 1, the first component of the dual-blockchain timestamping and recording process involves the Bitcoin Blockchain integration module 106, which submits both the digital media file cryptographic hash and the JSON proof object hash to the OpenTimestamps service for timestamping to the Bitcoin blockchain. The module interfaces with OpenTimestamps through standardized API endpoints using POST requests with appropriate content-type headers for hash submission and authentication keys for API integrity. OpenTimestamps operates as a decentralized timestamping service that provides cryptographic proof of document existence at specific points in time by timestamping hash values to Bitcoin transactions. This Bitcoin-based timestamping component focuses specifically on establishing long-term legal durability and evidentiary strength through Bitcoin's established legal recognition. The Bitcoin Blockchain integration module 106 implements communication protocols that handle the asynchronous nature of blockchain confirmations, including exponential backoff retry mechanisms with progressive delay intervals (2 s→4 s→8 s) up to 5 attempts and appropriate timeout handling for network interruptions or service unavailability.

The custom smart contract deployed on the Polygon network implements specific functions optimized for ownership verification. The primary function is a “storeJSON” function written in Solidity programming language. This function accepts the structured data object as input parameters and validates the data format. The smart contract stores lightweight metadata fields including song identification numbers, song names, user identification, user email addresses, user location data, registration timestamps, and collaborator split sheet information while maintaining data size constraints to optimize transaction costs and network efficiency. Upon successful validation, the function emits blockchain events containing the ownership information as permanent log entries stored in the blockchain's immutable transaction log. The smart contract implementation ensures that large media files remain off-chain while only cryptographic hashes and structured metadata objects are stored within the blockchain's immutable transaction records, thereby optimizing storage costs while maintaining verification capabilities.

The smart contract implementation ensures that large media files remain off-chain while storing only cryptographic hashes and structured metadata objects within the blockchain's immutable transaction records, thereby optimizing storage costs while maintaining verification capabilities. The stored metadata fields include song hash (unique SHA-256 hash of the file), song identification numbers (song_id), song names (song_name), user identification (user_name, user_email), user location data (user_country_name, user_state_name), registration timestamps (registered_at), splitsheet data containing collaborator percentage distributions, and OpenTimestamps hash references (data_ots_hash, song_ots_hash). This approach addresses blockchain transaction payload limitations by constraining data size while ensuring all essential ownership verification information remains permanently accessible and independently verifiable.

Upon successful OpenTimestamps processing, the Bitcoin Blockchain integration module 106 generates OpenTimestamps (.ots) files for both the original digital media file and the JSON proof object. The module receives binary .ots files from the OpenTimestamps service containing merkle path data and timestamp information that establishes cryptographic proof chains linking document hashes to specific Bitcoin blockchain transactions. An .ots file functions as a portable cryptographic proof document that establishes a specific document's existence at a specific time by containing the complete mathematical evidence needed to trace the document's hash back to its permanent record in the Bitcoin blockchain. These .ots files provide indefinite validity and can be independently verified by anyone using publicly available tools without requiring access to any centralized service. The Bitcoin Blockchain integration module 106 creates BASE-64 encoded versions of these .ots files for efficient integration within the system's data processing workflow and transmission through JSON objects.

After the Bitcoin timestamping process completes through the OpenTimestamps service, the second component of the dual-blockchain approach operates through the Polygon Blockchain integration module 108. This module submits the complete data package to a custom smart contract deployed on the Polygon network. As previously described, the complete data package is assembled after the Bitcoin processing phase completes and includes the JSON proof object containing all metadata, the SHA-256 hash of the digital media file, UTC timestamps, and artist collaboration data. The BASE-64 encoded .ots files from Bitcoin processing are incorporated into the data package before submission to the Polygon blockchain network.

For clarity, a smart contract is a computer program that runs automatically on the blockchain and executes predefined functions when specific conditions are met. The custom smart contract for this system implements a “storeJSON” function. This function is a programmed instruction that receives the ownership data and processes it for permanent blockchain storage. When this function executes, it emits blockchain events which are permanent log entries that record the transaction details. These events contain the submitted ownership data as payload, meaning the actual information being stored. The events ensure permanent storage within the Polygon blockchain's immutable transaction log, creating an unchangeable record that can be referenced indefinitely.

The Polygon Blockchain Integration module 108 implements transaction submission protocols that handle the technical aspects of blockchain communication and confirmation monitoring to ensure successful blockchain recording. The module utilizes API polling at predetermined intervals to monitor transaction status until confirmation is achieved, storing results in the system database alongside user metadata for certificate generation. Once recorded, the ownership data becomes part of the blockchain's permanent history and can be independently verified by anyone using blockchain explorers or verification tools through publicly searchable transaction hashes and block references on services like PolygonScan.

The Core Processing System 104 implements comprehensive error handling and recovery mechanisms to address potential blockchain submission failures while maintaining system reliability and user experience. The system implements detection protocols that monitor for non-2xx HTTP responses and abnormal response times exceeding predetermined thresholds (typically 5 seconds) to identify blockchain submission failures. When Bitcoin timestamping fails, the system cannot proceed to Polygon processing since the .ots files are required for the complete data package. The system generates a partial certificate containing only the processed hashes and metadata while flagging the certificate as requiring Bitcoin timestamping completion before Polygon submission can occur. For Bitcoin timestamping failures, the system automatically retries the OpenTimestamps submission using exponential backoff timing algorithms with progressive delay intervals (2 s→4 s→8 s) up to 5 attempts, and if all attempts fail, the system cannot proceed with Polygon verification while flagging the certificate as requiring Bitcoin timestamping completion. For Polygon smart contract failures after successful Bitcoin processing, the system similarly implements automatic retry mechanisms and can generate a partial certificate containing the completed Bitcoin timestamping evidence while maintaining a database-backed queue for subsequent Polygon submission attempts. The system implements real-time status monitoring and user notification protocols including progress updates during sequential blockchain processing and email alerts when processing delays exceed 2 hours. The system provides users with clear status notifications indicating sequential completion states and offers automated reprocessing capabilities to complete failed blockchain submissions when network conditions improve. For network congestion conditions, the system implements automatic re-broadcast mechanisms that resubmit transactions when they remain pending beyond predetermined time thresholds (typically 5 minutes). In cases where Bitcoin processing fails due to network outages or technical issues, the system preserves all processed data and metadata in secure temporary storage, enabling complete resubmission once connectivity is restored without requiring users to re-upload their original files or re-enter metadata.

Both blockchain integration modules provide transaction confirmations back to the Core Processing System 104, with Bitcoin module returning .ots files containing merkle path data and transaction references while Polygon module returns JSON responses containing transaction hashes, block numbers, and confirmation timestamps. The Core Processing System 104 validates these confirmations to ensure both blockchain submissions were successful and the data is permanently recorded on both networks. These blockchain coordinates are essential for enabling independent verification of the ownership claims and are stored in the system database for inclusion in digital ownership certificates.

### Process Phase 4—Certificate Generation Phase

Following successful completion of Phase 3 dual-blockchain timestamping and recording, the Core Processing System 104 coordinates with the System Output module 110 to generate the comprehensive digital ownership certificate package. The System Output module 110 assembles a compressed archive (proof.zip) that constitutes the digital ownership certificate package, containing all necessary components for independent ownership verification and creating a self-contained package that does not require access to the original system for validation purposes. The System Output module 110 collects the required components from various stages of the processing workflow to ensure the certificate package contains complete verification evidence. The certificate generation phase receives the original digital media file, .ots verification files, JSON proof object, and Polygon transaction references from Phase 3 as its inputs and coordinates all verification components through the System Output module 110 to create comprehensive ownership evidence packages.

The System Output module 110 retrieves components from their respective sources throughout the system architecture to assemble the proof.zip archive. In the preferred embodiment, the proof.zip archive contains the following components: (a) the original digital media file in its unmodified binary state as received from the User Input module 102, preserving bit-for-bit identical content; (b) a first OpenTimestamps file (.ots) for the digital media file generated by the Bitcoin Blockchain integration module 106, containing the cryptographic proof chain linking the file hash to Bitcoin blockchain transactions; (c) a second OpenTimestamps file (.ots) for the JSON proof object generated by the Bitcoin Blockchain integration module 106, providing independent Bitcoin verification of the metadata package; (d) the complete JSON proof object created by the Core Processing System 104, containing structured metadata, hash values, UTC timestamps, and ownership distribution information; (e) a Polygon transaction reference file generated by the Polygon Blockchain integration module 108, documenting the smart contract transaction ID and blockchain coordinates; (f) verification instructions and documentation generated by the System Output module 110, providing step-by-step guidance for independent validation using publicly available blockchain tools; and (g) a certificate summary report containing complete ownership details, all transaction identifiers, blockchain references, creator information, and certificate generation timestamps.

The System Output module 110 implements package integrity validation mechanisms that verify all components are present, uncorrupted, and maintain proper cryptographic relationships before final delivery. The System Output module 110 generates accompanying documentation that provides users with specific transaction identifiers, block references, and step-by-step verification instructions necessary for independent confirmation of ownership claims. This documentation enables users to validate their certificates using publicly available blockchain tools without requiring access to the original certification system.

### Process Phase 5—Verification Enablement Phase

The verification enablement phase receives the digital ownership certificate from Phase 4. The Public Verification module 112 enables independent third-party validation of ownership certificates without requiring access to the original system or any centralized database. This module provides the infrastructure and documentation necessary for completely autonomous verification using publicly available blockchain tools and services, ensuring that ownership evidence remains valid and verifiable regardless of the continued operation of the certification system.

The verification process supported by the Public Verification module 112 provides multiple independent validation pathways that enable any third party to confirm the authenticity of ownership certificates without requiring specialized technical knowledge or access to proprietary systems. The verification process includes hash comparison validation, where verifiers can take the digital media file provided in the certificate package and run it through the same SHA-256 hashing algorithm used during the original processing to generate a hash value, then compare this newly generated hash against the hash value stored in the certificate to confirm the file has not been altered since certification. This mathematical verification process proves file integrity through cryptographic means that are impossible to forge or manipulate. The public verification module 112 also supports .ots file validation against the Bitcoin blockchain using freely available OpenTimestamps verification tools, which allow independent confirmation of timestamp authenticity and blockchain anchoring without relying on any centralized verification service. The verification process walks users through accessing publicly available blockchain explorers to examine the Polygon smart contract entries, enabling direct inspection of the ownership data recorded on the blockchain network. These multiple verification pathways ensure that ownership evidence can be independently validated using standard internet tools and publicly accessible blockchain networks, creating a robust verification system that does not depend on the continued operation of any proprietary service or centralized authority.

For Polygon blockchain verification, the Public Verification module 112 provides comprehensive documentation and step-by-step references that enable third parties to locate and examine the smart contract entries using widely available blockchain explorers such as PolygonScan. These blockchain explorers function as publicly accessible search engines for blockchain data, allowing users to enter transaction IDs and view the complete record of what was stored on the blockchain network at any given time. This verification pathway provides independent confirmation of metadata storage by showing exactly what ownership information was recorded, transaction timing by displaying precise timestamps of when the data was submitted to the blockchain, and data integrity by allowing comparison between the certificate contents and the blockchain records. The verification process completes the end-to-end ownership verification workflow, creating a full audit trail from the initial creation of the digital media file through cryptographic processing, dual-blockchain timestamping and recording, certificate generation, and final independent validation by any interested party.

The system architecture ensures that all verification capabilities remain accessible through decentralized networks and publicly available tools, creating ownership evidence that maintains its validity and legal enforceability independent of any single service provider or centralized authority. Unlike traditional systems that can become obsolete or inaccessible if a company goes out of business or changes its policies, this blockchain-based approach stores ownership evidence on global networks maintained by thousands of independent participants worldwide. This independence represents a fundamental advantage over traditional copyright registration systems that rely on centralized databases and proprietary verification processes, which create single points of failure and require ongoing access to specific organizations or services. The decentralized approach ensures that ownership evidence remains permanently accessible and verifiable as long as the underlying blockchain networks continue to operate, providing creators with long-term security for their intellectual property rights that does not depend on any commercial entity's continued existence or cooperation.

The system ensures that users cannot permanently lose their Bitcoin Blockchain verification evidence by encoding OpenTimestamps (.ots) files in BASE-64 format within the JSON proof objects that are permanently stored on the Polygon blockchain network. This encoding enables users to decode the .ots data at any time to regenerate the original OpenTimestamps verification files. Users who retain their Polygon transaction identifiers can access the blockchain records and extract the encoded .ots files for independent verification purposes.

The system prevents users from permanently losing access to their ownership certificates by implementing database backup systems that enable recovery of critical blockchain coordinates when transaction identifiers are misplaced. Users may lose their Polygon transaction identifiers through device failures, file corruption, or accidental deletion, which would otherwise prevent access to their blockchain-stored ownership evidence. The system addresses this vulnerability by maintaining database backup systems that store cryptographic hashes, JSON metadata packages, and blockchain transaction identifiers generated during the ownership verification process. When users lose their transaction identifiers but retain other identifying information such as email addresses, file hashes, or registration timestamps, they can recover the specific Polygon transaction identifiers needed to access blockchain records. The database maintains records of all processing stages to enable access to blockchain coordinates and verification data when transaction identifiers are not available to users, ensuring that temporary loss of transaction identifiers does not result in permanent loss of ownership verification evidence.

The verification enablement phase establishes the independent validation capabilities that distinguish this system from centralized ownership verification approaches. Through the Public Verification module 112, this phase enables third-party validation without requiring access to the original system or any centralized database. The phase provides infrastructure for hash comparison validation, .ots file verification against the Bitcoin blockchain, and Polygon blockchain examination through publicly available blockchain explorers. This phase ensures that ownership evidence remains accessible and verifiable through decentralized networks, creating ownership certificates that maintain validity and legal enforceability independent of any single service provider or centralized authority.

The sequential execution of these five phases creates a comprehensive ownership verification workflow that transforms creative content into legally robust, independently verifiable evidence. Each phase contributes essential capabilities while building upon the foundation established by previous phases, resulting in self-contained ownership certificates that provide both immediate practical utility and long-term legal protection for creators' intellectual property rights.

### Detailed Method Flowchart

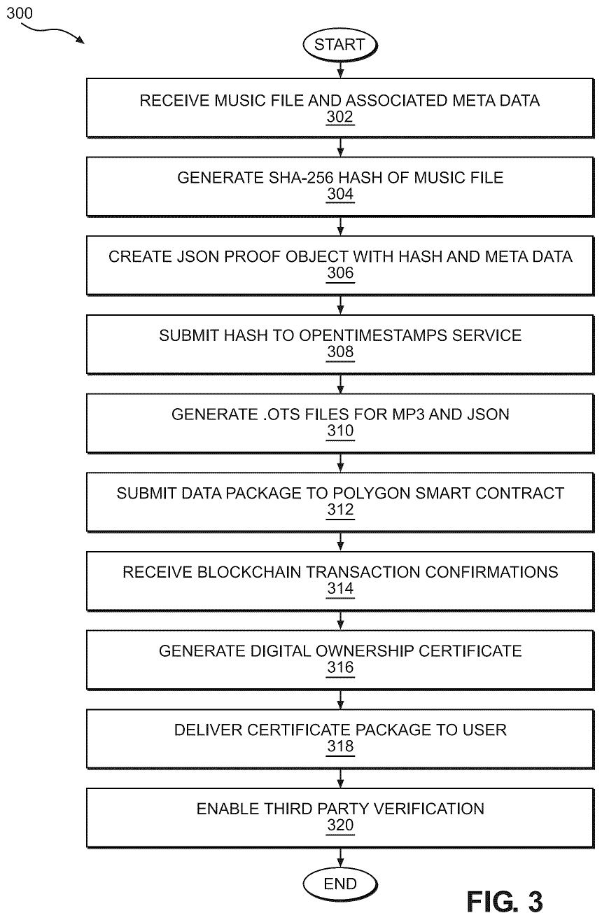

Referring now to FIG. 3, there is shown a flowchart illustrating the method of the present invention for blockchain-based digital media file ownership verification. The process begins at step 300 and proceeds sequentially through a series of processing stages that culminate in the generation and delivery of a tamper-proof ownership certificate.

At step 302, the system receives a digital media file and associated metadata from a user. The system implements comprehensive validation mechanisms that verify file format compatibility, enforce size limitations (e.g., 50 MB maximum), confirm metadata completeness, and validate that split sheet percentages total exactly 100% when multiple collaborators are involved. The digital media file is preferably in MP3 format, though other digital audio formats may be supported in alternative embodiments. The associated metadata includes essential ownership information such as the artist's name, song title, creation date, and split sheet data identifying any collaborators or co-writers and their respective ownership percentages. The system places all validated submissions into a database-backed queue for asynchronous processing while providing real-time status updates to users. The metadata collection process may include user interface elements that guide the creator through entering accurate ownership information, including validation checks to ensure split sheet percentages total exactly 100%.

At step 304, the system generates a SHA-256 cryptographic hash of the received digital media file locally within the secure processing environment before any external transmission occurs. This hash generation process reads the digital media file in its complete binary format without any compression, modification, or alteration, ensuring the hash represents the exact digital fingerprint of the original file as uploaded. The SHA-256 algorithm produces a unique 256-bit hash value that serves as a mathematical representation of the file's contents. Any subsequent alteration to the file, even a single bit change, would result in a completely different hash value, thereby providing cryptographic proof of file integrity. The system ensures that raw files are never transmitted to external blockchain providers, only the cryptographic hash values are submitted for timestamping and recording operations. The generated hash is stored temporarily in system memory along with metadata describing the file size, format, and timestamp of hash generation.

At step 306, the system creates a structured JSON proof object that combines the generated hash with the collected metadata. This JSON object serves as a comprehensive data package containing all relevant information about the digital media file and its ownership. The JSON structure includes fields for the song metadata (title, artist, creation date), the SHA-256 hash of the digital media file, UTC timestamp of registration, split sheet information detailing collaborator percentages, and file format data. In the preferred embodiment, the JSON object follows a predetermined schema that ensures consistency and compatibility with blockchain submission requirements. The JSON object itself becomes subject to hash generation for subsequent blockchain anchoring, creating a dual-layer verification system where both the original file and its metadata package are cryptographically protected.

At step 308, the system submits the generated hashes to the OpenTimestamps service for timestamping to the Bitcoin blockchain as described in the Bitcoin Blockchain integration module operation above. The system utilizes POST requests with appropriate content-type headers and authentication keys for API integrity when communicating with OpenTimestamps endpoints. This dual submission ensures that both the original digital media file and its associated metadata are independently verifiable through the Bitcoin blockchain, providing maximum legal and technical resilience for long-term archival purposes.

At step 310, the system generates two OpenTimestamps (.ots) files as described above in the Bitcoin Blockchain integration module operation. These files serve as portable, independently verifiable proof certificates that can be validated against the Bitcoin blockchain without requiring access to any centralized service or database.

At step 312, after Bitcoin processing completes, the system submits the complete data package to a custom smart contract deployed on the Polygon blockchain network. The system implements transaction submission protocols using POST requests with JSON payloads and appropriate authentication headers for secure API communication. The Polygon submission includes the complete metadata package, digital media file SHA-256 hash, BASE-64 encoded .ots files generated from the completed Bitcoin processing, JSON proof object, UTC timestamps, and artist collaboration data. The smart contract, implemented in Solidity, includes a “storeJSON” function that emits an event containing the metadata as payload. The smart contract stores lightweight metadata fields including song identification, user details, creation timestamps, and split sheet information while maintaining data size constraints to optimize transaction costs. This event data is permanently stored on the Polygon blockchain, providing fast, low-cost access to the ownership record while maintaining the security benefits of blockchain immutability. The sequential dual-blockchain approach first establishes Bitcoin's legal recognition for long-term archival strength, then leverages Polygon's speed and cost-effectiveness for subsequent verification needs.

At step 314, the system receives blockchain transaction confirmations from both the OpenTimestamps service and the Polygon network. The system implements API polling at predetermined intervals to monitor transaction status until confirmation is achieved, with Bitcoin processing returning .ots files containing merkle path data and Polygon processing returning JSON responses with transaction hashes, block numbers, and timestamps. These confirmations include specific transaction identifiers, block references, and timestamps that prove successful anchoring of the ownership data to both blockchains. The system validates these confirmations to ensure the blockchain submissions were successful and the data is permanently recorded. The system implements automatic retry mechanisms with exponential backoff for failed transactions and provides real-time status updates to users during the confirmation process. Transaction IDs and block references are stored for inclusion in the final ownership certificate, providing users with the specific blockchain coordinates needed for independent verification of their ownership claims.

At step 316, the system generates a comprehensive digital ownership certificate package. The certificate generation process typically completes within 75-150 minutes depending on Bitcoin blockchain confirmation timing, providing users with access to ownership evidence once both blockchain networks have confirmed the transactions. This certificate is assembled as a compressed archive (proof.zip) containing the original digital media file (unchanged from upload), the generated .ots files for both the digital media file and JSON objects, the JSON proof object containing all metadata and hash information, and a text file containing the Polygon transaction hash and relevant blockchain references. The system implements package integrity validation mechanisms that verify all components are present, uncorrupted, and maintain proper cryptographic relationships before final delivery. The certificate package is designed to be self-contained, enabling independent third-party verification without requiring access to the original system or any centralized database. All files within the package maintain their cryptographic integrity, allowing verification of the complete chain of custody from original file to blockchain timestamping and recording.

At step 318, the system delivers the completed certificate package to the user through a secure download mechanism. The system provides real-time notifications including email alerts confirming certificate generation and availability for download. The user receives the proof.zip file along with a summary report detailing the Polygon transaction ID, Bitcoin block references via OpenTimestamps, and instructions for verification and legal usage. The delivery process includes validation of package integrity before transmission, ensuring all required files are present and uncorrupted. The system provides comprehensive documentation explaining how the certificate serves as corroborating evidence that complements existing copyright registration systems rather than replacing formal copyright procedures. Users are provided with guidance on how to use the certificate package for copyright protection, DMCA counterclaims, licensing negotiations, and other legal proceedings requiring proof of authorship.

At step 320, the system enables third-party verification capabilities through public blockchain lookups. The certificate package contains all necessary information for independent parties to verify the authenticity and timestamp of the ownership claim without requiring access to the original system. Verification involves hash comparison validation where verifiers generate SHA-256 hashes of provided files and compare against certificate values, .ots file validation against Bitcoin blockchain using publicly available OpenTimestamps tools, and Polygon smart contract examination through blockchain explorers like PolygonScan using transaction identifiers. This verification process can be performed using publicly available blockchain network explorers and OpenTimestamps validation tools, ensuring the ownership evidence remains accessible and verifiable regardless of the continued operation of the original certification system. The system provides comprehensive step-by-step verification instructions and documentation that enable completely autonomous validation without requiring specialized technical knowledge.

The process concludes at the END step, having successfully created a tamper-proof, independently verifiable ownership certificate that provides both immediate accessibility through Polygon blockchain network records and long-term legal durability through Bitcoin blockchain timestamping via OpenTimestamps.

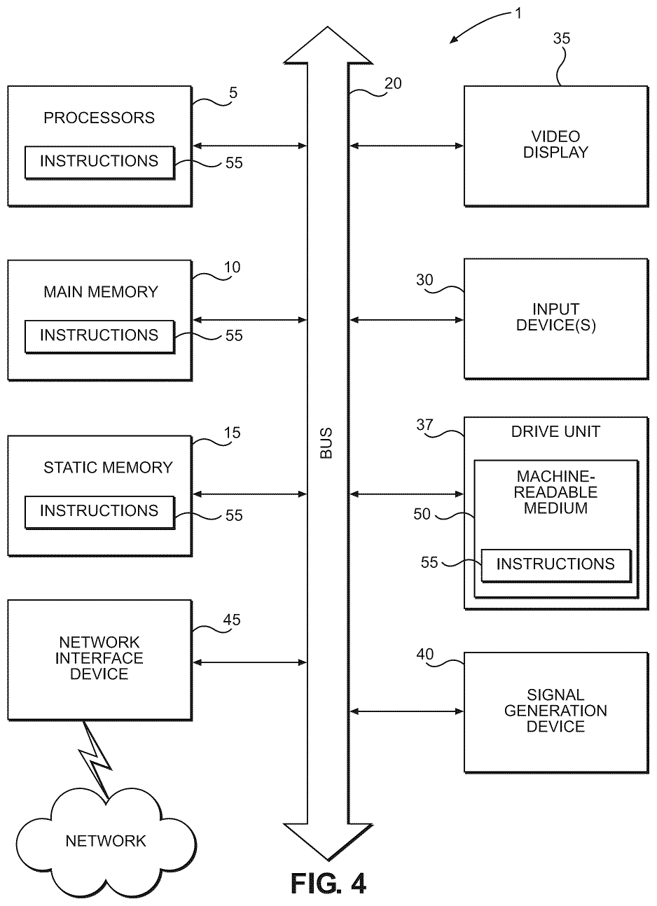

FIG. 4 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be an Internet-of-Things device or system, a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

The components provided in the computer system 1 of FIG. 4 are those typically found in computer systems that may be suitable for use with embodiments of the present disclosure and are intended to represent a broad category of such computer components that are well known in the art. Thus, the computer system 1 can be an Internet-of-Things device or system, a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

In some embodiments, the computer system 1 may be implemented as a cloud-based computing environment, such as a virtual machine operating within a computing cloud. In other embodiments, the computer system 1 may itself include a cloud-based computing environment, where the functionalities of the computer system 1 are executed in a distributed fashion. Thus, the computer system 1, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the computer device 1, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications, as well as wireless communications (both short-range and long-range). Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The foregoing detailed description includes references to the accompanying drawings, which form a part of the detailed description. The drawings show illustrations in accordance with exemplary embodiments. These example embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the invention in the form disclosed. Many modifications and variations will be apparent to those of ordinary skill in the art without departing from the scope and spirit of the invention.

While specific blockchain networks, programming languages, and timing specifications are described herein as preferred embodiments, it should be understood that equivalent blockchain networks, compatible programming languages, and substantially similar timing parameters may be substituted without departing from the scope of the invention. References to specific networks such as Bitcoin and Polygon are exemplary, and the invention encompasses implementation on any blockchain networks providing substantially equivalent timestamping and smart contract functionality.

What is claimed:

1. A computer-implemented method, comprising:
receiving a digital media file and associated metadata from a user;
generating a cryptographic hash of the digital media file locally before external transmission;
creating a structured data object containing the cryptographic hash and the associated metadata formatted as a JSON object according to a predetermined schema;
implementing a database-backed queue management for asynchronous blockchain submission processing;
submitting the cryptographic hash to a first blockchain network configured for timestamping services that generate OpenTimestamps (.ots) proof files;
receiving, from the first blockchain network, a first transaction identifier and first block reference corresponding to the timestamping operation along with OpenTimestamps (.ots) proof data;
incorporating the OpenTimestamps (.ots) proof data into the structured data object;
submitting the structured data object to a second different blockchain network configured for smart contract execution and data recording using secure API communication protocols with authentication headers;
receiving, from the second blockchain network, a second transaction identifier and second block reference corresponding to the recording operation;
confirming successful timestamping and recording of the cryptographic hash and structured data object based on the first transaction identifier, the second transaction identifier, the first block reference, and the second block reference; and
generating a self-contained digital ownership certificate containing the digital media file, the first transaction identifier, the second transaction identifier, the first block reference, the second block reference, the OpenTimestamps (.ots) proof data, and verification instructions enabling independent third-party validation without centralized system access.

2. The method according to claim 1, further comprising:
implementing error detection monitoring for non-2xx HTTP responses and abnormal response times.

3. The method according to claim 1, further comprising:
implementing exponential backoff retry mechanisms for failed blockchain submissions.

4. The method according to claim 1, further comprising:
providing verification tools that enable third parties to independently validate the digital ownership certificate using publicly available blockchain networks without requiring access to centralized systems; and
providing the digital ownership certificate to the user.

5. The method according to claim 1, wherein the digital media file comprises a musical composition in a digital format, and wherein the associated metadata includes:
artist identification information with cryptographic signatures;
creation timestamps with time zone specifications;
split sheet information defining precise ownership percentages among multiple creators with creator wallet addresses; and
copyright registration information where available.

6. The method according to claim 1, wherein the first blockchain network comprises a Bitcoin-compatible network providing OpenTimestamps services, and the second blockchain network comprises an Ethereum-compatible network executing smart contracts for immutable data storage.

7. The method according to claim 1, wherein timestamping the cryptographic hash using the timestamping service generates OpenTimestamps (.ots) files that contain cryptographic proof chains linking the hash to specific blockchain transactions.

8. The method according to claim 1, further comprising encoding the OpenTimestamps (.ots) files in BASE-64 format for efficient storage and transmission, wherein the OpenTimestamps (.ots) files enable independent validation of the timestamping without requiring access to centralized services.

9. The method according to claim 1, wherein generating the cryptographic hash comprises:
reading complete binary content of the digital media file in sequential byte order without any modification, compression, or format conversion; and
applying a SHA-256 cryptographic hashing algorithm to the unmodified binary content to generate a unique 256-bit hash value serving as a digital fingerprint of the file content,
verifying hash generation integrity by comparing against a secondary hash computation, thereby ensuring the hash represents the exact and verifiable digital fingerprint of the original file as uploaded.

10. The method according to claim 1, wherein creating the structured data object comprises formatting the cryptographic hash and associated metadata into a JSON object according to a predetermined schema that includes standardized fields for blockchain compatibility and cross-platform interoperability.

11. A system, comprising:
a processor; and a memory for storing instructions, the instructions being executed by the processor to:
receive a digital media file and associated metadata from a user;
generate a cryptographic hash of the digital media file locally before external transmission;
create a structured data object containing the cryptographic hash and the associated metadata formatted as a JSON object according to a predetermined schema;
implement a database-backed queue management for asynchronous blockchain submission processing;
submit the cryptographic hash to a first blockchain network configured for timestamping services that generate OpenTimestamps (.ots) proof files;
receive, from the first blockchain network, a first transaction identifier and first block reference corresponding to the timestamping operation along with OpenTimestamps (.ots) proof data;
incorporate the OpenTimestamps (.ots) proof data into the structured data object;
submit the structured data object to a second different blockchain network configured for smart contract execution and data recording using secure API communication protocols with authentication headers;
receive, from the second blockchain network, a second transaction identifier and second block reference corresponding to the recording operation;
confirm successful timestamping and recording of the cryptographic hash and structured data object based on the first transaction identifier, the second transaction identifier, the first block reference, and the second block reference; and
generate a self-contained digital ownership certificate containing the digital media file, the first transaction identifier, the second transaction identifier, the first block reference, the second block reference, the OpenTimestamps (.ots) proof data, and verification instructions enabling independent third-party validation without centralized system access.

12. The system according to claim 11, wherein the processor is further configured to:
implement error detection monitoring for non-2xx HTTP responses and abnormal response times.

13. The system according to claim 11, wherein the processor is further configured to:
implement exponential backoff retry mechanisms for failed blockchain submissions.

14. The system according to claim 11, wherein the processor is further configured to:
provide verification tools that enable third parties to independently validate the digital ownership certificate using publicly available blockchain networks without requiring access to centralized systems; and
provide the digital ownership certificate to the user.

15. The system according to claim 11, wherein the digital media file comprises a musical composition in a digital format, and wherein the associated metadata includes:
artist identification information with cryptographic signatures;
creation timestamps with time zone specifications;
split sheet information defining precise ownership percentages among multiple creators with creator wallet addresses; and
copyright registration information where available.

16. The system according to claim 11, wherein the processor is further configured to:
validate the digital media file format compatibility with supported formats;
enforce predetermined size limitations; and
confirm metadata completeness including verification of the split sheet information defining ownership percentages among multiple creators; and
validate cryptographic signatures of all listed creators.

17. The system according to claim 11, wherein the processor is configured to interface with a first blockchain network comprising a Bitcoin-compatible network providing OpenTimestamps services, and a second blockchain network comprising an Ethereum-compatible network executing smart contracts for immutable data storage.

18. The system according to claim 11, wherein the processor is configured to:
generate OpenTimestamps (.ots) files through the timestamping service, wherein the files contain cryptographic proof chains linking the hash to specific blockchain transactions.

19. The system according to claim 11, wherein the processor is further configured to:
encode the OpenTimestamps (.ots) files in BASE-64 format for efficient storage and transmission, wherein the OpenTimestamps (.ots) files enable independent validation of the timestamping without requiring access to centralized services.

20. The system according to claim 11, wherein the processor is configured to generate the cryptographic hash by:
reading complete binary content of the digital media file in sequential byte order without any modification, compression or format conversion; and
applying a SHA-256 cryptographic hashing algorithm to the unmodified binary content to generate a unique 256-bit hash value serving as a digital fingerprint of the file content; and
verifying hash integrity by comparing against a secondary hash computation, thereby ensuring the hash represents the exact and verifiable digital fingerprint of the original file as uploaded.

21. The system according to claim 11, wherein creating the structured data object comprises the processor formatting the cryptographic hash and associated metadata into a JSON object according to a predetermined schema for blockchain compatibility.

22. The system according to claim 11, wherein the processor is further configured to:
implement blockchain network health monitoring and automatic retry mechanisms that detect blockchain submission failures; and
upon detecting a failure in one blockchain network, automatically attempt retry operations with exponential backoff timing; and
generate a partial ownership certificate containing successful blockchain verification data and status information indicating which network operations completed successfully.

23. A non-transitory computer-readable storage medium storing instructions that, when executed by one or more processors, cause the processors to perform operations comprising:
receiving a digital media file and associated metadata from a user;
generating a cryptographic hash of the digital media file locally before external transmission;
creating a structured data object containing the cryptographic hash and the associated metadata formatted as a JSON object according to a predetermined schema;
implementing a database-backed queue management for asynchronous blockchain submission processing;
submitting the cryptographic hash to a first blockchain network configured for timestamping services that generate OpenTimestamps (.ots) proof files;
receiving, from the first blockchain network, a first transaction identifier and first block reference corresponding to the timestamping operation along with OpenTimestamps (.ots) proof data;
incorporating the OpenTimestamps (.ots) proof data into the structured data object;
submitting the structured data object to a second different blockchain network configured for smart contract execution and data recording using secure API communication protocols with authentication headers;
receiving, from the second blockchain network, a second transaction identifier and second block reference corresponding to the recording operation;
confirming successful timestamping and recording of the cryptographic hash and structured data object based on the first transaction identifier, the second transaction identifier, the first block reference, and the second block reference; and
generating a self-contained digital ownership certificate containing the digital media file, the first transaction identifier, the second transaction identifier, the first block reference, the second block reference, the OpenTimestamps (.ots) proof data, and verification instructions enabling independent third-party validation without centralized system access.

24. The non-transitory computer-readable storage medium according to claim 23, wherein the operations further comprise:
providing verification tools that enable third parties to independently validate the digital ownership certificate using publicly available blockchain networks without requiring access to centralized systems; and
providing the digital ownership certificate to the user.

25. The non-transitory computer-readable storage medium according to claim 23, wherein the digital media file comprises a musical composition, and wherein the associated metadata includes artist identification information, creation timestamps, and split sheet information defining ownership percentages among multiple creators.
